(19) United States
(12) Patent Application Publication
(10) Pub. No.: US 2008/0160383 A1
(43) Pub. Date: Jul. 3, 2008

(54) FUEL CELL MODULE WITH THERMAL FEEDBACK MECHANISM

(75) Inventors: Chia-Chieh SHEN, Hsinchu (TW); Justin C.P. CHOU, Hsinchu City (TW); Tsong-Pyng PERNG, Hsinchu (TW)

Correspondence Address: EGBERT LAW OFFICES, 412 MAIN STREET, 7TH FLOOR, HOUSTON, TX, 77002, US

(73) Assignee: NATIONAL TSING HUA UNIVERSITY, Hsinchu (TW)

(21) Appl. No.: 11/617,619

(22) Filed: Dec. 28, 2006

(51) Int. Cl. H01M 2/00

(52) U.S. Cl. 429/34

(57) ABSTRACT

The present invention relates to a fuel cell module with a thermal feedback mechanism. The fuel cell module includes a hydrogen storage container, a fuel cell body and a housing. The hydrogen storage container has a tank, a valve, and hydrogen storage alloy. The fuel cell body is integrated with the hydrogen storage container, such that the electricity-generating part of the fuel cell body faces the hydrogen storage container. Furthermore, heat generated from the electrochemical reaction can be fed back to the hydrogen storage container. This heat could increase the temperature of the hydrogen storage container, leading to a more stable discharge reaction and subsequently improving the performance of the fuel cell.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a fuel cell module and more particularly to an innovation with a thermal feedback mechanism.

### BACKGROUND OF THE INVENTION

Fuel cells are commonly used to directly convert the chemical energy stored in fuel into electric power. Fuel cells generate electricity if fuel and oxygen are continuously supplied. Since the performance of fuel cells is free from the limitation of Carnot cycle, fuel cells are characterized by higher energy conversion efficiency, higher levels of specific power, and pollution-free generator stack, etc. Fuel cells can also provide centralized power generation and distributed power supply at a higher degree of power-generating efficiency, while overcoming the excessive conversion loss in energy transmission from the boiler or steam turbine to the generator within a thermal power plant.

In practice, a fuel cell must be integrated into a fuel cell module together with a hydrogen storage container, a fuel cell body and a housing. As for the methods of hydrogen storage, use of solid hydrogen storage alloy is a proven technology that provides hydrogen fuel with higher safety. According to the storage principle, hydrogen molecules on a metallic surface are decomposed into hydrogen atoms and then diffuse into the interstitial sites of the lattice to form hydride bonds with metallic atoms. Thus, a unit volume storage density 10 times of traditional high pressure steel cylinder is obtained. The decomposition pressure of hydride could be controlled at approximately one atmospheric pressure via fine adjustment of composition. Such a low-pressure will prevent cracking of the proton exchange membrane, which is a key component within the fuel cell. Moreover, a reversible hydriding/dehydriding characteristic permits the hydrogen storage alloys to be refilled with and supplied from hydrogen for prolonged cycling.

To ensure a more stable discharge reaction during hydrogen release, heat is supplied to the hydrogen storage container, since dehydriding of the solid hydrogen storage alloy is an endothermic reaction. So far, prior art solutions to this problem are not satisfactory, such that the temperature of the hydrogen storage container decreases during dehydriding, leading to unstable current discharge as well as degraded reliability of the fuel cell. If the fuel cell module has an extra heating unit, the complication of the structural configuration of the fuel cell module increases, not to mention the additional issue of including a corresponding power supply mechanism for this extra heating unit.

Thus, to overcome the aforementioned problems of the prior art, it would be an advancement in the art to provide an improved structure that can significantly improve the stability of the released hydrogen flow.

To this end, the inventors have provided the present practicable invention after deliberate invention and evaluation based on the years of experience in the production, development and creation of related products.

### BRIEF SUMMARY OF THE INVENTION

The fuel cell body 20 is integrated with the hydrogen storage container 10 in a compact space, wherein an electricity-generating part 21 of fuel cell body 20 faces the hydrogen storage container 10. The heat generated from the electrochemical reaction within the fuel cell body 20 can be fed back to the hydrogen storage container 10. In this way, the hydrogen storage container 10 is warmed, thereby achieving a more stable dehydriding reaction and subsequently improving reliable output power from the fuel cell.

The heat conductor 40 is mounted externally onto the hydrogen storage container 10. The heat generated from the electricity-generating part 21 of fuel cell body 20 can be accumulated and then transmitted to the hydrogen storage container 10 through the heat conductor 40, achieving a better heat storage efficiency for hydrogen storage container 10.

Furthermore, the amount of hydrogen released from hydrogen storage container 10 can be varied by regulating the actuated-displacement of the stem 121 within the valve 12 via the adjuster 50. The different output power of the fuel cell can be obtained by the adjuster 50 so as to meet different user requirements.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a radial cross-sectional view of the fuel cell module which is the first preferred embodiment of the present invention.

FIG. 2 shows an axial cross-sectional view of the fuel cell module which is the first preferred embodiment of the present invention.

FIG. 3 shows a perspective view of the first adjuster, which is illustrated in the first preferred embodiment of the present invention.

FIG. 4 shows a cross-sectional view of the valve.

FIG. 5 shows another cross-sectional view of the valve.

FIG. 6 shows a third cross-sectional view of the valve.

FIG. 7 shows a cross-sectional view of the second adjuster, which is illustrated in the first preferred embodiment of the present invention.

FIG. 8 shows an elevation view of an interior of the fuel cell module which is the second preferred embodiment of the present invention.

FIG. 9 shows an elevation view of an interior of the fuel cell module which is the third preferred embodiment of the present invention.

FIG. 10 shows a cross-sectional view of the third adjuster in the “ON” state, which is illustrated in the first preferred embodiment of the present invention.

FIG. 11 shows a detailed cross-sectional view of the third adjuster in the “OFF” state, which is illustrated in the first preferred embodiment of the present invention.

### DETAILED DESCRIPTION OF THE INVENTION

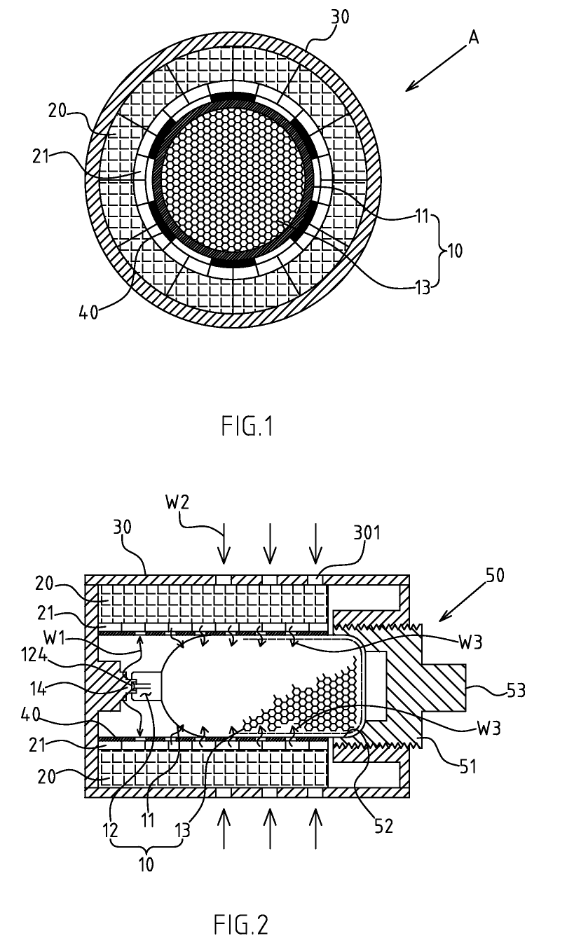

FIGS. 1 and 2 depict the first preferred embodiments of a fuel cell module with a thermal feedback mechanism, provided only for explanatory purposes of the patent claims. The fuel cell module A comprises a hydrogen storage container 10, a fuel cell body 20 and a housing 30. The hydrogen storage container 10 can be cylindrical and comprises a tank 11, a hydrogen outlet 110, a valve 12 adapted to the hydrogen outlet 110 and hydrogen storage alloy 13 filled within the tank 11. Oxygen can be supplied from the air inlet 301 of the housing 30. The fuel cell body 20 is integrated with the hydrogen storage container 10 in a compact space such that the electricity-generating part 21 of fuel cell body 20 faces the hydrogen storage container 10. The heat generated from the electrochemical reaction can be fed back to the hydrogen storage container 10. In this way, the hydrogen storage container 10 is warmed, thereby achieving a more stable discharge reaction and improving the performance of fuel cell.

Referring to FIG. 1, the fuel cell body 20 is integrated with the hydrogen storage container 10 in a compact space. The fuel cell body 20 in the first preferred embodiment is placed circularly around an outside of the tank 11 of hydrogen storage container 10. Moreover, heat conductor 40 can have the form of a sleeve, being mounted externally outside the hydrogen storage container 10. Made of materials with good heat conductivity, e.g. copper, the heat conductor is used to absorb the heat emitted from electricity-generating part 21 of fuel cell body 20. Thereby, the heat storage efficiency in hydrogen storage container 10 will be greatly increased.

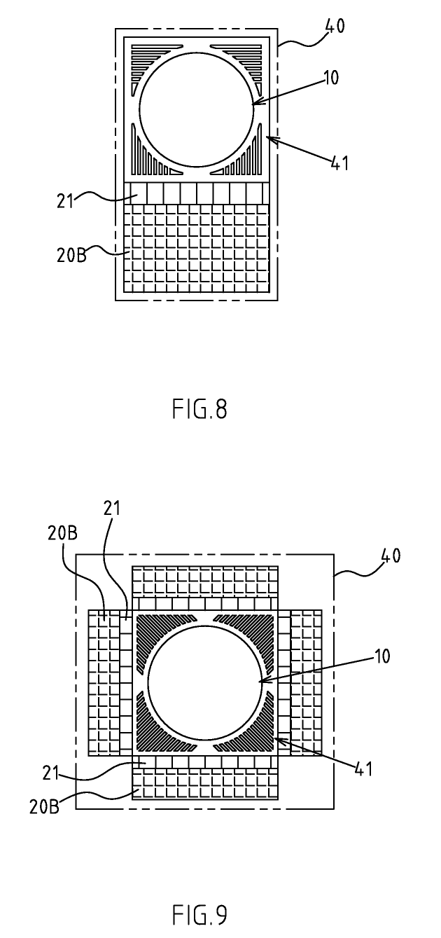

Referring also to FIG. 8, the fuel cell body 20B is placed at one side of the hydrogen storage container 10, which is the second preferred embodiment of the present invention. If the hydrogen storage container 10 is typically cylindrical, a square heat conductor frame 41 is used to improve the heat conducting efficiency from the electricity-generating part 21 of fuel cell body 20B to the hydrogen storage container 10. Moreover, referring to FIG. 9, the fuel cell body 20B can also be placed separately at four sides of the square heat conductor frame 41, which develops the third preferred embodiment in the present invention.

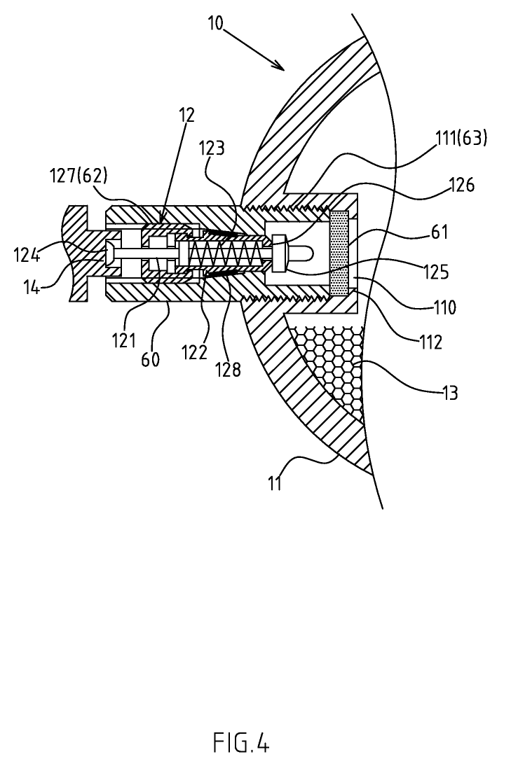

Referring to FIG. 2, the operation of the valve 12 of hydrogen storage container 10 can be controlled in a forced-press manner through an adjuster 50. FIG. 4 shows the internal structure of valve 12, which comprises a stem 121, a sleeve 122, a spring 123, a filter 61 and a valve body 60. When a stem tip 124 at the exterior stem 121 is pressed, the stem 121 slides along the axial direction of sleeve 122, making the valve 12 open gradually. To close the valve 12, stem seal 125 at the internal stem 121 is forced into contact with the sleeve end 126 of sleeve 122 via the relaxation of spring 123. The valve body 60 can also be sealed with the help of the sleeve seal 128. A tapered seal configuration is illustrated in this preferred embodiment, showing the body front thread 62 being tightened with the sleeve thread 127 of sleeve 122. Besides, the valve body 60 can be positioned at the hydrogen outlet 110 of hydrogen storage container 10 through the coupling of the body rear thread 63 with the tank thread 111. The installation of filter 61 located between an inner end of valve body 60 and flange 112 prevents hydrogen storage alloy particles from flowing out, making the operation of valve 12 reliable and workable.

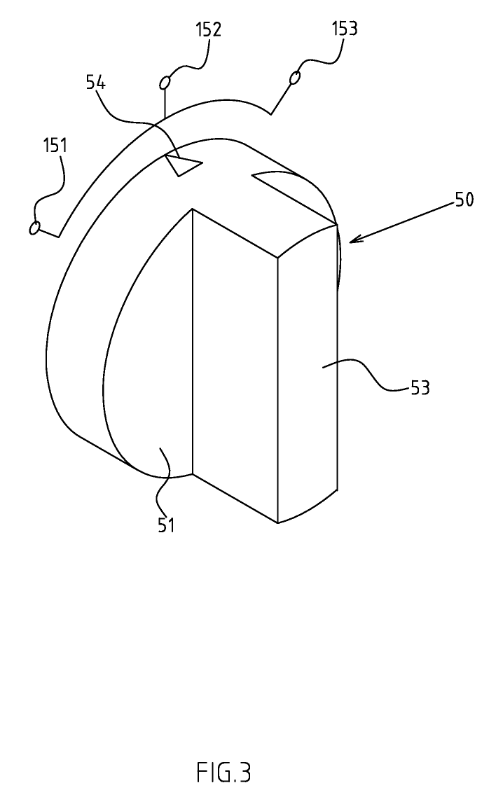

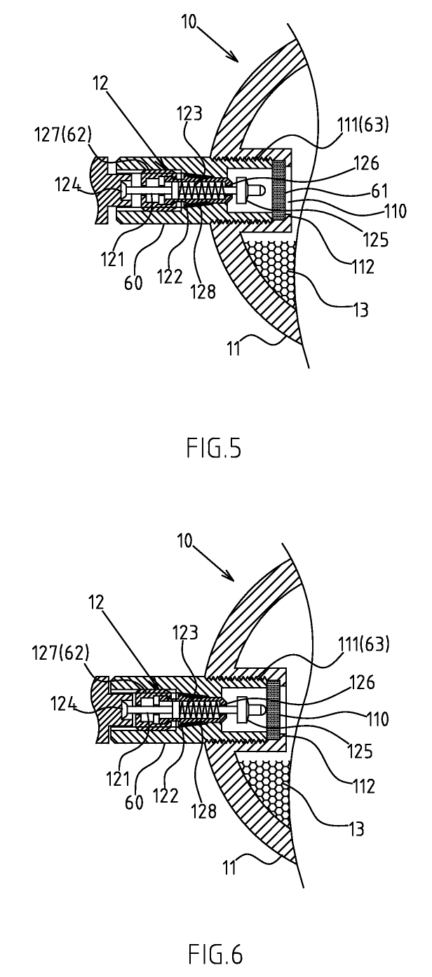

The adjuster 50 to control the valve 12 can be a screwing seat 51. The hydrogen storage container 10 is inserted into the socket 52 of screwing seat 51. The stem tip 124 within the valve 12 is gradually pressed with the striker 14 of socket 52 by the rotator 53 of adjuster 50 so that the amount of hydrogen released from the hydrogen storage container 10 can be adjusted via the regulation on the actuated-displacement of the stem 121. The values of different amounts of hydrogen flow can be read by the scales 151, 152 and 153 placed on the surface of the hydrogen storage container 10 with the help of the indicator 54 on the surface of the adjuster, referring to FIG. 3. For example, when the mark 54 of the rotator 53 points to the first scale 151, it indicates that the valve 12 is under the “OFF” state, as seen in FIG. 4. Second, when the mark 54 of rotator 53 points to the scale 152, the valve 12 is configured as shown in FIG. 5. The stem seal 125 of stem 121 is slightly separated from the sleeve end 126 of sleeve 122, leading to the smaller hydrogen flow. Finally, when the mark 54 of the rotator 53 points to the scale 153, the valve 12 is configured as shown in FIG. 6. In such case, the stem seal 125 of stem 121 is visibly separated from the sleeve end 126 of sleeve 122 so that a larger hydrogen flow is obtained.

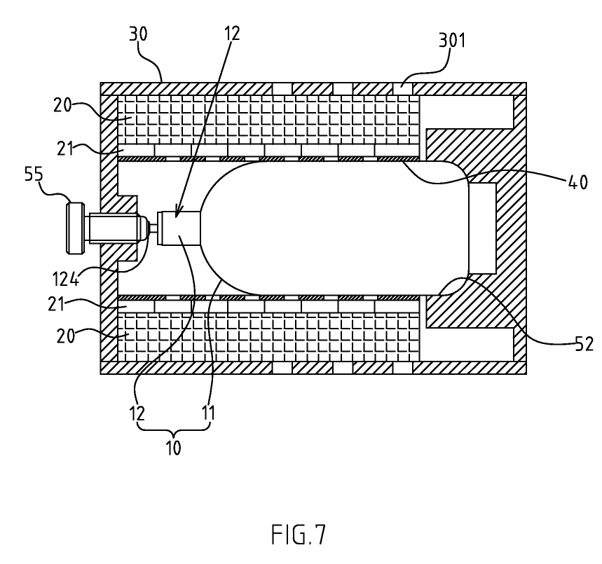

Referring to FIG. 7, the second adjuster to control the valve 12 is illustrated, in which the rotator placed near the side of valve 12 is a bolt 55. Similar to the first adjuster, the stem tip 124 within the valve 12 is gradually pressed with the inner end of bolt 55 so that the amount of hydrogen released from the hydrogen storage container 10 can be adjusted.

Based upon above the structural design, the preferred embodiment of the present invention is operated as follows:

Referring to FIG. 2, to activate the fuel cell module A of the present invention, the valve 12 must be opened to release hydrogen W1 from the hydrogen storage container 10, and the external oxygen W2 is supplied from air inlet 301 of the housing 30. The electrochemical reaction of hydrogen W1 and oxygen W2 can take place at the electricity-generating part 21 of fuel cell body 20, when the electric power is obtained. Furthermore, the heat W3 generated from the electrochemical reaction can be fed back to the hydrogen storage container 10 through the heat conductor 40. The temperature of the hydrogen storage container 10 is increased, leading to a more stable dehydriding reaction and subsequently improving the performance of the fuel cell module A.

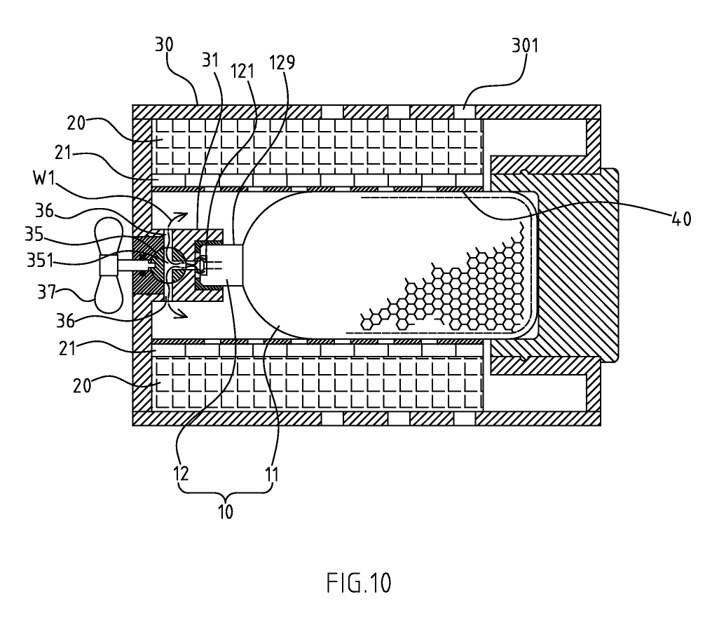

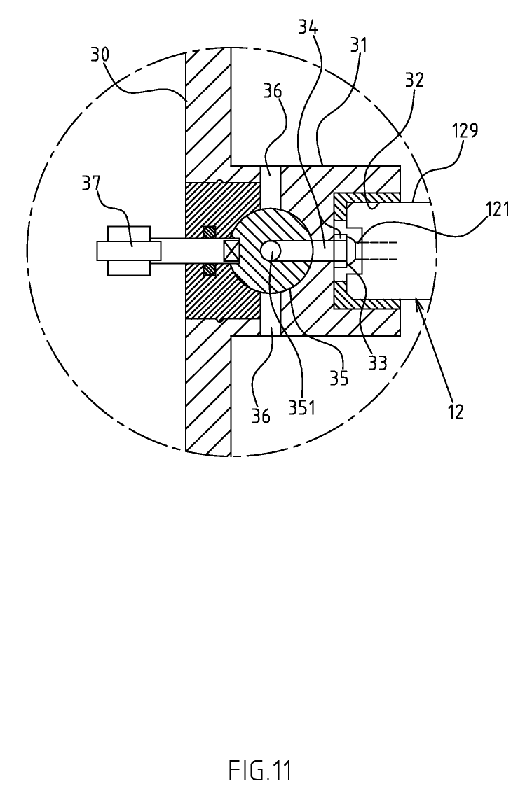

FIG. 10 shows the third adjuster to control the valve 12. In this preferred embodiment of the present invention, the operation of valve 12 is also controlled in a forced-press manner. A protruding tube 129 at an exterior of valve 12 is closely inserted into the inner circle 32 of the protruding part 31 within the housing 30 such that the stem tip 124 of stem 121 within the valve 12 can be pressed by the striker 33 within the inner circle 32. The striker 33 is laterally connected via a channel 34 to the ball valve 35 within the protruding part 31. The ball valve 35 has an internal T-shape tunnel 351, with its outlet connected to a guided channel 36 accessible to both sides of the protruding part 31. The other end of ball valve 35 is installed with a handle 37 outside the housing 30 so that the switch of valve 12 or the amount of hydrogen flow W1 can be controlled accordingly via the extent of rotation by the handle 37. FIG. 10 shows the active state of the ball valve 35, and FIG. 11 shows the inactive state of the ball valve 35.

We claim:

1. A fuel cell module comprising:
a hydrogen storage container being comprised of a tank, a hydrogen outlet, and a valve adapted to said hydrogen outlet;
a fuel cell body in contact with said hydrogen storage container; and
an enclosure housing said hydrogen storage container and said fuel cell body, wherein said hydrogen storage container and said fuel cell body are integrated together so that heat generated from an electrochemical reaction in said fuel cell body is fed back to said hydrogen storage container.

2. The fuel cell module defined in claim 1, wherein said hydrogen storage container is comprised of a hydrogen tank filled with hydrogen storage alloy.

3. The fuel cell module defined in claim 1, wherein said fuel cell body is placed circularly around said hydrogen storage container.

4. The fuel cell module defined in claim 1, wherein said fuel cell body is placed at one side of said hydrogen storage container.

5. The fuel cell module defined in claim 1, further comprising:
a plurality of heat conductors mounted externally onto said hydrogen storage container.

6. The fuel cell module defined in claim 1, wherein said valve of said hydrogen storage container is controlled in a forced-press manner through an adjuster, an amount of hydrogen released from said hydrogen storage tank being regulated by said adjuster.

7. The fuel cell module defined in claim 6, wherein said valve is comprised of a stem, a sleeve, a spring, a filter, and a valve body, said stem sliding along an axial direction of said sleeve by press and being reset via said spring, said stem having a stem tip at an exterior thereof, said adjuster having a striker at an inner side thereof, said striker pressing said stem tip to control said valve by a switch, said sleeve having a seal to prevent hydrogen leakage from said hydrogen storage container by fixing a thread of said valve body with a thread of said sleeve, said hydrogen outlet of said hydrogen storage container having a thread portion to position said valve body, said filter being located between an inner end of said valve body and said hydrogen outlet.

8. The fuel cell module defined in claim 6, wherein said adjuster is comprised of a screwing seat, said screwing seat having a socket at an inner end thereof, said socket positioning said hydrogen storage container, said screwing seat having a rotator located opposite to said valve, said rotator being able to adjust an amount of hydrogen released from said hydrogen storage container via regulation by actuated-displacement of said stem.

9. The fuel cell module defined in claim 6, wherein said adjuster is comprised of a screwing seat, said screwing seat having a rotator located closely to said valve so that said stem tip is gradually pressed by an inner end of said rotator, regulating an amount of hydrogen flow released from said hydrogen storage container via regulation on actuated-displacement of said stem.

10. The fuel cell module defined in claim 6, further comprising:
a plurality of scales being placed onto said hydrogen storage container and indicating an amount of hydrogen released from said hydrogen storage container via regulation of said adjuster.
